(19) United States
(12) Patent Application Publication
(10) Pub. No.: US 2002/0020068 A1
(43) Pub. Date: Feb. 21, 2002

(54) Electrical power tool with a latch mechanism

(76) Inventor: Markus Hartmann, Mauerstetten (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/928,776

(22) Filed: Aug. 13, 2001

(30) Foreign Application Priority Data
Aug. 17, 2000 (DE) 100 40 334.4

(51) Int. Cl. B23D 45/16

(52) U.S. Cl. 30/388

(57) ABSTRACT

A manually operated, electrical power tool, including a motor-driven shaft (9) located in the tool housing (1) and to which a working tool (9) is securable with a locking device having a locking and release positions in which the working tool (9) is secured on or is freely supported on the shaft (9), a braking member (17) secured on the shaft (19) for interrupting 7rotation of the shaft (19) in the release position of the working tool locking device; and a latch mechanism for positively engaging the braking member in the release position of the working tool locking device for blocking rotation of the shaft.

### BACKGROUND OF THE INVENTION

1. Field of the Invention

The present invention relates to a manually operated, electrical power tool, in particular, to circular saw, manual planer and the like, including a housing, a motor-driven shaft located in the housing and to which a working tool is securable with a locking device having a locking position in which the working tool is secured on the shaft, and a release position in which the working tool is not secured on the shaft and can be removed, and a braking element provided on the shaft for interrupting rotation of the shaft in the release position of the working tool locking device.

2. Description of the Prior Art

Electrical power tools of the type described above usually have a safety member which prevents the displacement of the working tool locking device from its locking position into its release position if, e.g., the shaft-driving motor is on. In this way, the safety member prevents any damage of the working tool or other treatable object which might have been caused by an erroneous manipulation of the working tool locking device. Further, the safety member prevents an inadvertent actuation of the shaft-driving motor or turning it on. In these tools, the braking device serves for braking the motor and/or the working tool and insures that the power tool remains idle when the working tool is being replaced.

An electrical power tool of the type described above is disclosed in e.g., in European Patent EP-B1-319813. In the disclosed power tool, there is provided a motor that drives, via a gear mechanism, the tool shaft. A working tool is secured on the shaft with a locking device. At one end of the tool shaft, there is provided an actuation element for displacing the locking device between its locking and release positions. Between the locking device and the actuation element, there is provided, on the tool shaft, a shaft-locking device which is actuated by the actuation element. The shaft-locking device includes a coupling with claws which engage in complementary recesses provided in the tool shaft. A spring-biased annular disc displaces the claws out of the recesses. In order to brake or lock the tool shaft, the actuation element is displaced into a position, which corresponds to the release position of the working tool locking device, and displaces the claws into the shaft recesses against the biasing force of the annular disc. Upon engagement of the claws in the recesses, the rotation of the shaft relative to the housing is interrupted. Upon displacement of the actuation element into a position, which corresponds to the locking position of the working tool locking device, the annular disc displaces the claws out of the shaft recesses.

With the solution described above, the tool shaft is blocked without the participation of a user of the power tool in retaining of the working tool working device in its release position. As a result, the user can use both hands, e.g., to replace the working tool. Upon displacement of the working tool locking device into its locking position, the blocking of the tool shaft is ceases.

The drawback of the known power tool consists in that the locking device occupies a large space and the locking means is provided at and end of the locking device. In particular, in annually operated circular saws, extension of the housing in the axial direction of the shaft is undesirable, as this makes the use of the power tool in some locations very difficult or even makes it impossible.

In addition, in the known power tool, large forces are required for blocking the shaft which, in turn, results in the use of more massive parts.

Moreover, the complicated construction of the locking means makes the manufacturing of the power tool more expensive.

Accordingly, an object of the present invention is to provide a manually operated electrical power tool with compact locking means that can be economically manufactured.

Another object of the present invention is to provide a manually operated electrical power tool with compact locking means and which can be used in poorly accessible locations.

### SUMMARY OF THE INVENTION

This and other objects of the present invention, which will become apparent hereinafter, are achieved by providing, on the shaft, a braking member and a latch mechanism for positively engaging the braking member in the release position of the working tool locking device for blocking rotation of the shaft in the release position of the working tool working device.

By providing a braking member for mounting on the shaft and which can be engaged by a latching mechanism, it became possible to block or brake the shaft at almost any point along the shaft axis. This also permitted to reduce the space required for the locking mechanism, in particular, in the longitudinal direction of the shaft axis which, in turn, permitted to improve the handling of the power tool. It also permitted, in particular, to use a manually operated circular saw in locations which are difficult to access. Also, the compactness of the power tool reduce the need in storage space. In addition, the latch mechanism is subjected only to small forces as it works together with the braking member. As a result, a larger operating lever acts on the latch mechanism during the locking process, which reduces the forces acting on the latching mechanism in comparison with forces acting on conventional latch or blocking devices. Therefore, the use of smaller and less rigid parts for the latching or blocking mechanism does not reduce the service life of the power tool.

It is possible to secure the braking member on the shaft of the tool shaft-driving electric motor, in particular when a gear mechanism is provided between the tool shaft and the motor output shaft for increasing the working tool-side torque.

Advantageously, the braking member is formed as a braking drum which is fixedly secured on the shaft. A braking drum is a very stable part and is capable of absorbing significant forces. Obviously, other parts, different from the braking drum, can be secured on the shaft for engagement by the latching mechanism, such as, e.g., as a fan wheel or a magnetic ring.

Advantageously, the power tool according to the present invention includes an actuation element for displacing the working tool locking device between its locking and release positions, The latch mechanism has a member that positively engages the braking drum when the actuation element occupies a position corresponding to the release position of the working tool locking device. The actuation element is held in its position corresponding to the release position of the working tool locking device and the blocking position of the latch mechanism by a safety member, which controls the operation of the motor switch, when the safety member occupies a position in which the motor switch or trigger in non-operative, i.e., a safety position. In this way, the shaft is automatically blocked in case the safety member is in its safety position.

Advantageously, the braking drum has at least one recess formed in its outer circumference, and the latch mechanism includes a latch member and a spring for biasing the latch member into the recess formed in the outer circumference of the braking drum in the position of the actuation element corresponding to the release position of the working tool locking device.

In this way, in the safety position of the safety switch, the latch member engages the recess of the drum. If the latch member engages an outer surface of the braking drum upon actuation of the actuation member, rotation of the drum insures that almost instantaneously the latch snaps into a respective recess when the latch member is opposite a radial projection region of the recess.

Forming the locking means as a latch member engageable into a recess formed in the drum provides for an economical manufacturing of the power tool. Providing the receiving recesses in the outer circumference of the braking drum also permits to obtain a compact structure as the latch mechanism occupies a radial and not an axial space. The number of recesses, which can be formed in the outer circumference of the drum is determined by the drum diameter. By selecting an appropriate drum diameter, such number of recesses can be provided that the engagement of the latch member in a recess would take place at a very small rotational angle of the drum. When the braking drum and the latch mechanism are located in the front section of the shaft, the drum diameter can be make smaller with a smaller number of recesses. A smaller drum diameter provides for smaller overall dimensions of the entire structure. However, a smaller number of recesses leads to increase of the rotational angle of the drum prior to latching.

Preferably, the latch member is pivotally secured to the tool housing with a bolt, which insures simple and economical manufacture of the power tool. Obviously, the housing can have an auxiliary structure for supporting the bolt. The auxiliary structure can be integrally formed with the housing as a one-piece part.

Advantageously, the latch mechanism can include a pivot member which is also secured to the housing by the bolt with which the latch member is secured to the housing. The spring, which biases the latch member toward the braking drum, is formed as a torsional spring that biases the pivot member against the latch member about the rotational axis defined by the common bolt. The latching mechanism is actuated upon a pivotal movement of the pivot member in a direction toward the braking drum. Upon the pivotal movement of the pivot member in the opposite direction, the latch member disengages from the drum, providing for rotation of the drum and, thereby, the shaft relative to the housing. The pivot elements, the latch and pivot members, form a very compact structure and require little mounting space.

Advantageously, the actuation element includes control tracks which contact the pivot member and pivot the same upon actuation of the actuation element. The latching mechanism and the actuation element form an integral structure which can be mounted in or removed from the power tool as a unit. In this way the assembly and the repair of the power tool is greatly simplified. The pivot member, advantageously, is provided with a locking tongue, which preloads the pivot member against the housing, whereby, a contact of the pivot member with the control tracks is insured.

Advantageously, the latching mechanism is formed from a plastic material by injection-molding, generally, a very economical process. If necessary, particularly high-loaded elements, such as the bolt, are formed of a more rigid material, e.g., metal or the like.

The novel features of the present invention, which are considered as characteristic for the invention, are set forth in the appended claims. The invention itself, however, both as to is construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a perspective view of an electrical power tool according to the present invention;

FIG. 2 a perspective view of the actuation element of the power tool shown in FIG. 1 at an increased, in comparison with FIG. 1, scale;

FIG. 3 a perspective view of a gear mechanism cover with a latch mechanism of the power tool shown in FIG. 1 at an increase, in comparison with FIG. 1, scale;

FIG. 4 a perspective side view of a snap-on latch mechanism according to the present invention with a braking drum in a non-latched condition thereof; and

FIG. 5 a perspective side view of the snap-on latch mechanism shown in FIG. 4 in a latched condition thereof.

### DETAILED DESCRIPTION OF THE PREFERRED EMBODIMENT

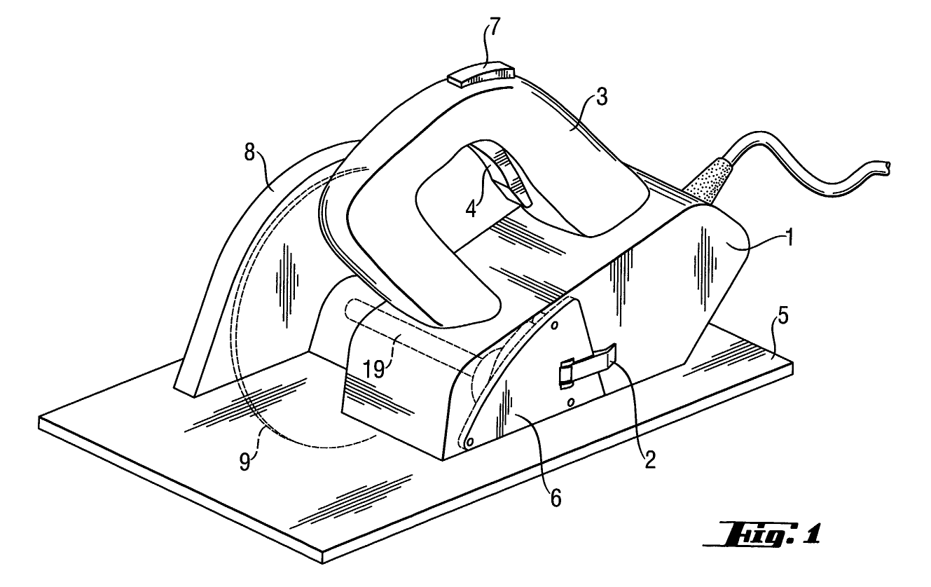

An electrical power tool according to the present invention, which is shown in FIG. 1, includes a housing 1 and a motor-driven circular working tool 9. The working tool 9 is secured on a motor-driven shaft 19 with a locking device (not shown) that is actuated by an actuation element 2.

A gear mechanism cover 6 connects the actuation element 2 with the housing 1. The housing 1 has a handle 3 provided with a trigger 4 for turning the circular working tool-driving motor on and off, and a safety member 7. The working circular tool 9 is partially surrounded by a protective hood 8. For the displacement of the electrical power tool, the power tool is provided with a bearing plate 5. The circular working circular tool 9 extends through the bearing plate 5.

The turning of the working tool-driving motor with the trigger 4 is possible only in a depressed position of the trigger 4 which corresponds to a released position of the safety member 7. In the depressed position of the trigger 4, the safety member is locked in its release position. Upon turning of the working tool-driving motor off with the trigger 4, the safety member 7 is displaced from its release position into its safety position. In the safety position of the safety member 7, release of the locking device, with which the working tool 9 is secured on the shaft 19, with the actuation element 2 becomes possible.

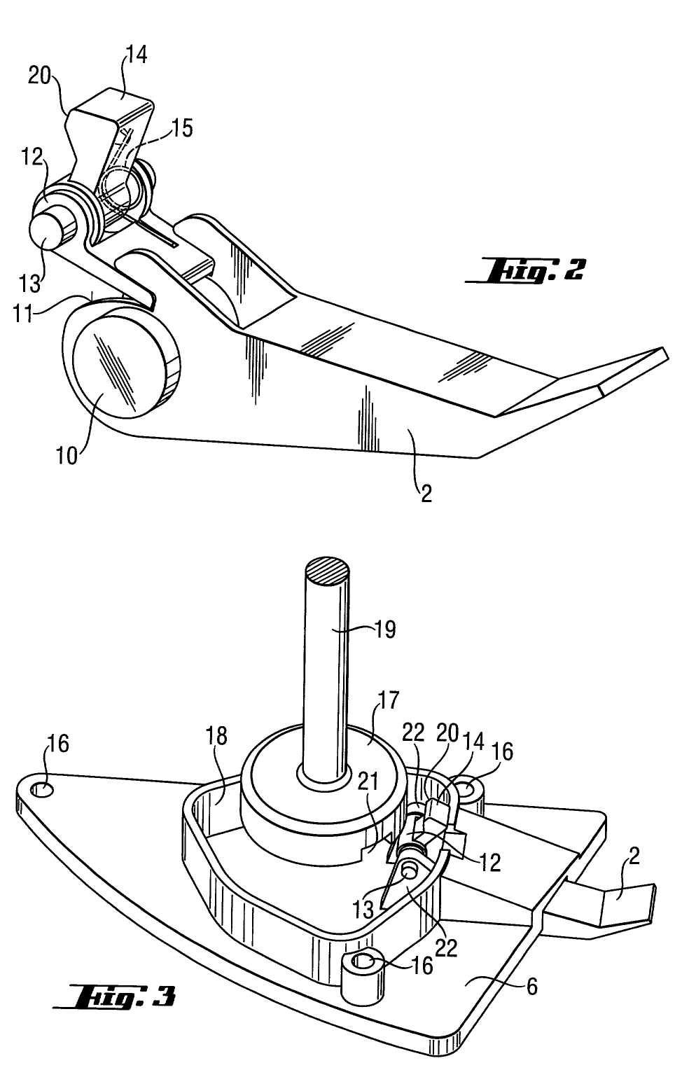

The actuation element 2, which is shown in detail in FIG. 2, is provided at one of its end with a guide member 10 that pivotally supports the actuation element 2 in the gear mechanism cover 6, and with two, extending parallel to each other, control tracks 11 that cooperate with a pivot member 12. A bolt 13 pivotally connects the pivot member 12 to the gear mechanism cover 6 and, thereby, with the power tool housing 1, as it is particularly shown in FIG. 3.

The pivot member 12 has, in the region of the bolt 13, a groove in which a latch member 14 is supported. The latch member 14 is perloaded against the pivot member 12 with a torsional spring 15.

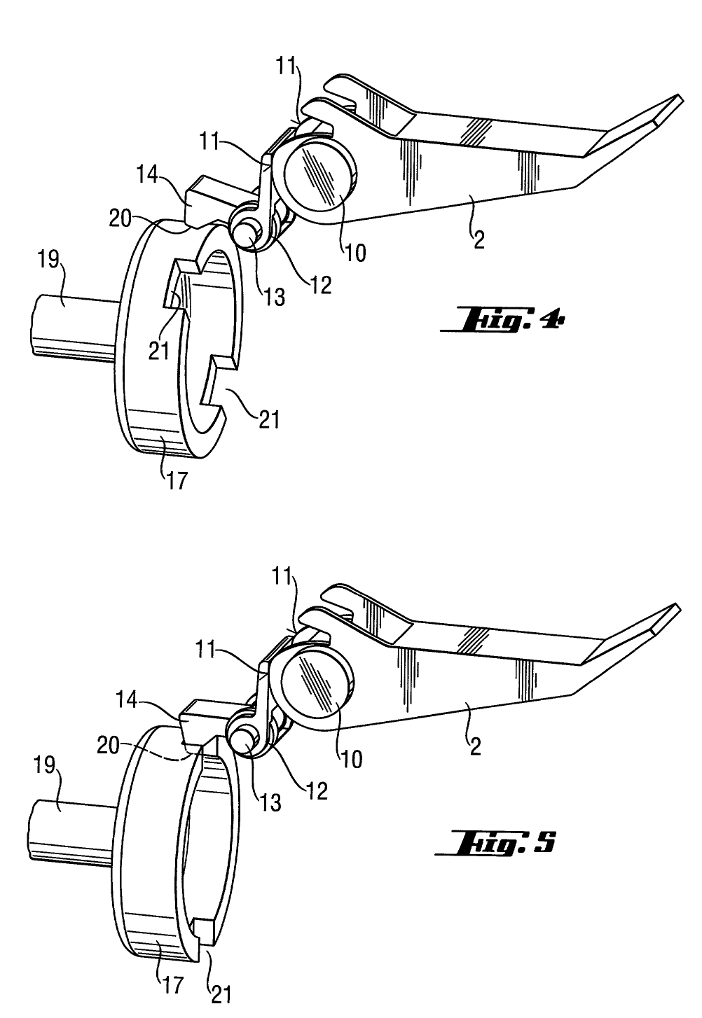

The gear mechanism cover 6 has a plurality of bores 16 through which screws, which secure the cover 6 to the housing 1, extend. In its middle, the cover 6 has a space 16 for receiving a braking drum 17 that is secured on the shaft 19 which extends through the cover 6. The particularities of the braking drum 17 are shown in FIGS. 4-5. For supporting the bolt 13 in the cover 6, there are provided two brackets 22 in the cover 6.

FIGS. 4-5 show a latch mechanism for blocking the actuation element 2 and the braking drum 17 which is, as it has been discussed previously, secured on the shaft 19. Upon displacement of the actuation element 2 from a position, in which the working tool locking device is in its locking position, to a position in which the working tool locking device is in its release position, the control tracks 1 1 of the actuation element 2 pivot the pivot member 12 toward the braking drum 17. The torsional spring 15 transmits the torque from the pivot member 12 to the latch member 14. The latch member 14 has a locking leg 20 which is spring-biased against the outer circumference of the braking drum 17. The braking drum 17 has a plurality of recesses 21 formed in its circumference and into which the locking leg 20 of the latch member 14 can engage. When the locking leg 20 is located against a recess 21, the locking leg 20 would be biased into the recess 21 by the tortional spring 15. When the locking leg 20 is engaged in the recess 21, the rotation of the braking drum 17 and, thereby, of the shaft 19 are interrupted. Upon displacement of the actuation element 2 from its position, which corresponds to the release position of the working tool locking device, into its position which corresponds to the locking position of the working tool locking device, the pivot member 12 pivots in the opposite direction, and the locking leg 20 becomes disengaged from a respective recess 21 in the outer circumference of the braking drum 17. Now, the rotation of the shaft 19 can resume.

Though the present invention was shown and described with references to the preferred embodiment, such are merely illustrative of the present invention and are not to be construed as a limitation thereof, and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A manually operated, electrical power tool, comprising a housing (1); a motor-driven shaft (19) located in the housing (1) and to which a working tool (9) is securable with a locking device having a locking position in which the working tool (9) is secured on the shaft (19), and a release position in which the working tool (9) is not secured on the shaft (19) and can be removed; a braking member (17) secured on the shaft (19) for interrupting rotation of the shaft (19) in the release position of the working tool locking device; and a latch mechanism for positively engaging the braking member (17) in the release position of the working tool locking device for blocking rotation of the shaft (19) in the release position of the working tool locking device.

2. An electrical power tool according to claim 1, wherein the braking member comprises a braking drum.

3. An electrical power tool according to claim 2, further comprising an actuation element (2) for displacing the working tool locking device between the locking and release positions thereof, and wherein the latch mechanism comprises means that positively engages the braking drum when the actuation element (2) occupies a position corresponding to the release position of the working tool locking device.

4. An electrical power tool according to claim 3, wherein the braking drum (17) has at least one recess (21) formed in an outer circumference thereof, and wherein the latch mechanism comprises a latch member (14) and a spring (15) for biasing the latch member (14) into the recess (21) formed in the outer circumference of the braking drum (17) in the position of the actuation element (2) corresponding to the release position of the working tool locking device.

5. An electrical power tool according to claim 4, further comprising a bolt (13) for pivotally securing the latch member (14) in the housing (1).

6. An electrical power tool according to claim 5, wherein the latch mechanism comprises a pivot member (12), which is also secured to the housing (1) by the bolt (13), and wherein the spring (15) is formed as a torsional spring which biases the pivot member (12) against the latch member (14) about the rotational axis defined by the bolt (13).

7. An electrical power tool according to claim 6, wherein the actuation element (2) has control tracks ( 11) for pivoting the pivot member (12) of the latch mechanism upon displacement of the actuation member from a position thereof corresponding to the locking position of the working tool locking device to a position thereof corresponding to the release position of the working tool locking device.

8. An electrical power tool according to claim 1, wherein the latch mechanism is formed of a plastic material.
